(19) United States
(12) Patent Application Publication
(10) Pub. No.: US 2012/0226626 A1
(43) Pub. Date: Sep. 6, 2012

(54) SYSTEM AND METHOD FOR CREATING BUSINESS INTELLIGENCE DASHBOARD MOCKUPS

(75) Inventors: Pushkala VENKATESWARAN, Hyderabad (IN); Venkateswaran Venkatasubramanian, Hyderabad (IN); Vikas Bansal, Cupertino, CA (US); Vikram Takru, Cupertino, CA (US)

(73) Assignee: Enterprise Signal Inc., Cupertino, CA (US)

(21) Appl. No.: 13/039,332

(22) Filed: Mar. 3, 2011

(51) Int. Cl. G06Q 10/00

(52) U.S. Cl. 705/342

(57) ABSTRACT

In accordance with one embodiment of present disclosure, a system and a method for creating business intelligence dashboard mockups are provided. The system includes a questioning module, a dashboard generating module and a display module. The questioning module is capable of receiving an input data, from a user. The dashboard generating module includes a data source and a dashboard generating module that includes a data generator module. The data generator module is configured to calculate one or more random measures by analyzing one or more values from the input data. Further, the data generator module is configured to generate one or more reports based on the one or more random measures and the input data. Further, the display module is configured for enabling the user to view the one or more reports. Furthermore, the system facilitates the user to modify the data source to modify the reports.

### FIELD OF INVENTION

The present disclosure relates to the field of business intelligence, and more particularly to creating dashboard mockups for business intelligence.

### BACKGROUND

Business intelligence (BI) involves analyzing business data corresponding to various business operations. Most of the companies prepare reports for their internal departments to determine and analyze performance of each of the departments. Further, the reports are generated for market analysis to know history, current scenario and the predictive view of business operations.

Further, typically, a requirement gathering phase, of a Business Intelligence (BI) system, involves manual storyboarding or manual dashboard model generation. In this phase of BI system, a layout and a view of each report need to be finalized. Such manual generated dashboard model may be represented through excel. This consumes a significant time and effort of the user in storyboarding or preparing the dashboard mockup manually.

Further, for such manual preparation of dashboard mockup includes collection of data, manually, to prepare charts and tables for presenting in any report. Conventionally, if a user wants to layout one or more reports for different departments of a company, the user may be required to collect data from each of the departments separately to generate the reports. Further, the user needs to change the reports every time whenever the data corresponding to any of the departments changes. Also, the data in each chart of a report should be tailored to the needs of a customer (or the company). Further, the charts and, information corresponding thereto, in each report should be consistent with respect to business scenario. For example, if the margin on Gold Product Category is lower than Silver Product Category, then the corresponding sales report on product categories, should include information on such change in margin on product categories. For this, the user needs to change the report frequently with any change in business trend and according to the need of the customer. Due to this, the user needs to put extra effort and time in preparing the report with updated data corresponding to latest business trend.

Generally, the user uses Pen on Paper approach to collect the data. Getting data continuously from each department individually, to regenerate dashboard model manually to present one or more reports, is a time and effort consuming process. Also, the report may be generated from the collected data by utilizing a sample prototype. The user needs to enter whole collected data in the prototype corresponding to each report of every department to generate all reports of the company. Further, as the number of reports increases, time to generate the reports and thus to generate the dashboard mockup will also be increased due to more data entry for generating the reports. This makes the process of report generation tedious and time consuming. Further, entering the whole data for report generation increases the chances of typographical errors and may lead to incorrect report generation.

In light of the foregoing discussion, there is a need for a method and a system for creating business intelligence dashboard mockups or story lines.

### SUMMARY

Embodiments of the present disclosure mentioned herein describe a method and a system for creating business intelligence dashboard mockups or story lines.

In one embodiment, the present disclosure provides a computer-implemented method for creating business intelligence dashboard mockup. The method includes receiving an input data, from a user, for a questionnaire. The method further includes calculating one or more random measures by analyzing one or more values from the input data. Further, the method generates one or more reports based on at least one of the one or more random measures and the input data. The one or more reports beings generated for one or more report types based on the input data. Further, the method enables the user to view and modify the one or more reports. The reports are modified by the user by modifying the input data. By this, the user is enabled to regenerate the one or more reports.

In another embodiment, the present disclosure provides an online system for creating business intelligence dashboard mockup. The system includes a questioning module, a dashboard generating module and a display module. The questioning module is capable of receiving an input data, from a user, for a questionnaire. The dashboard generating module includes a data source for storing the input data. Further, the dashboard generating module includes a data generator module. The data generator module is configured to calculate one or more random measures by analyzing one or more values from the input data. Further, the data generator module is configured to generate one or more reports based on the one or more random measures and the input data. The one or more reports are generated for one or more report types based on the input data. Further, the display module is configured for enabling the user to view the one or more reports. Furthermore, the system facilitates the user to modify the input data in the data source to modify the one or more reports.

### BRIEF DESCRIPTION OF FIGURES

In the accompanying figures, similar reference numerals refer to identical or functionally similar elements. These reference numerals are used in the detailed description to illustrate various embodiments and to explain various aspects and advantages of the present disclosure.

FIG. 1 illustrates a block diagram of the environment to implement a system, in accordance with various embodiments of the disclosure;

FIG. 2 illustrates a block diagram of a system for creating business intelligence dashboard mockup, in accordance with an embodiment of the disclosure;

FIG. 3 is a flowchart illustrating a method for creating business intelligence dashboard mockup, in accordance with an embodiment of the disclosure;

FIG. 4 illustrates an exemplary view of questionnaire uploading screen, in accordance with an embodiment of the disclosure;

FIG. 5 is an exemplary database, in accordance with one embodiment of the disclosure;

FIG. 6 illustrates an exemplary dashboard mock-up generated by implementing the method, in accordance with an embodiment of the present disclosure;

FIG. 7 illustrates an exemplary view of questionnaire for creating business intelligence dashboard mockup, in accordance with an embodiment of the present disclosure; and

FIGS. 8A-8D illustrate exemplary view of business intelligence dashboard mockup corresponding to the questionnaire illustrated in FIG. 7, in accordance with an embodiment of the present disclosure.

The method has been represented where appropriate by conventional symbols in the drawings, showing only those specific details that are pertinent for understanding the embodiments of the present disclosure so as not to obscure the disclosure with details that will be readily apparent to those of ordinary skill in the art having the benefit of the description herein.

### DETAILED DESCRIPTION

It may be observed that the components of the system and method steps have been represented by conventional symbols in the figure, showing only specific details which are relevant for an understanding of the present disclosure. Further details may be readily apparent to person ordinarily skilled in the art, and may not have been disclosed. In the present disclosure, relational terms, may be used to distinguish one entity from another entity, without necessarily implying any actual relationship or order between such entities.

Embodiments in the present disclosure as described herein provide a system and a method for creating a business intelligence dashboard mockup. Business intelligence system involves providing reports in various view modes in an arrangement referred to as “dashboard”. Further, the system enables visualizing the dashboard through the layout of the tables, charts, pivot tables and prompts.

The system is an automated online tool for creating business intelligence dashboard mockup. The system collects input data, from a user, through a questionnaire and generates the dashboard based on the input data. In an embodiment, each question of the questionnaire may represent a data field in a table that stores at least one value from the input data. Further, the system is capable of generating data based on data ranges provided by the user through input data. The generated data may be utilized for generating charts/graphs for the repots.

The system enables the user to modify the data and view a modified graph, without having a need to redraw the graph.

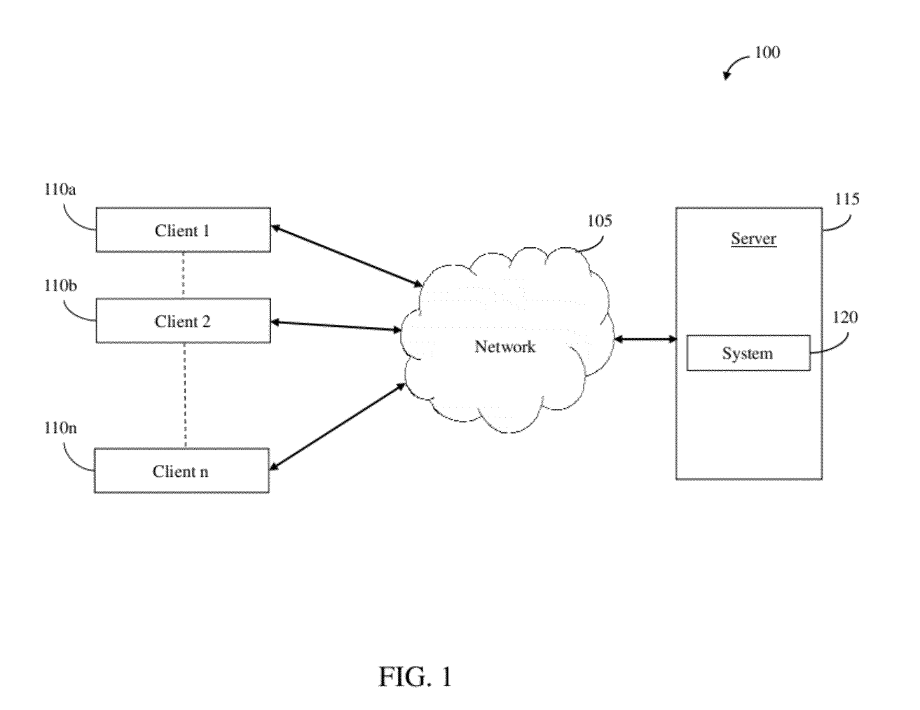

FIG. 1 illustrates a block diagram of an environment 100, in accordance with various embodiments of the disclosure. The environment 100 includes a network 105 connected to one or more users' systems (electronic devices) such as client 1 110a, client 2 110b . . . to client n 110n (hereinafter collectively referred to as “clients 110”) and a server 115. The network 105 may include, but is not restricted to, a Local Area Network (LAN), a Wireless Local Area Network (WLAN), a Wide Area Network (WAN), Internet, and a Small Area Network (SAN). The client 110 may include one or more electronic devices that may be utilized by one or more users. Further, the server 115 may include an electronic device that may be in electronic communications with the client 110 through the network 105.

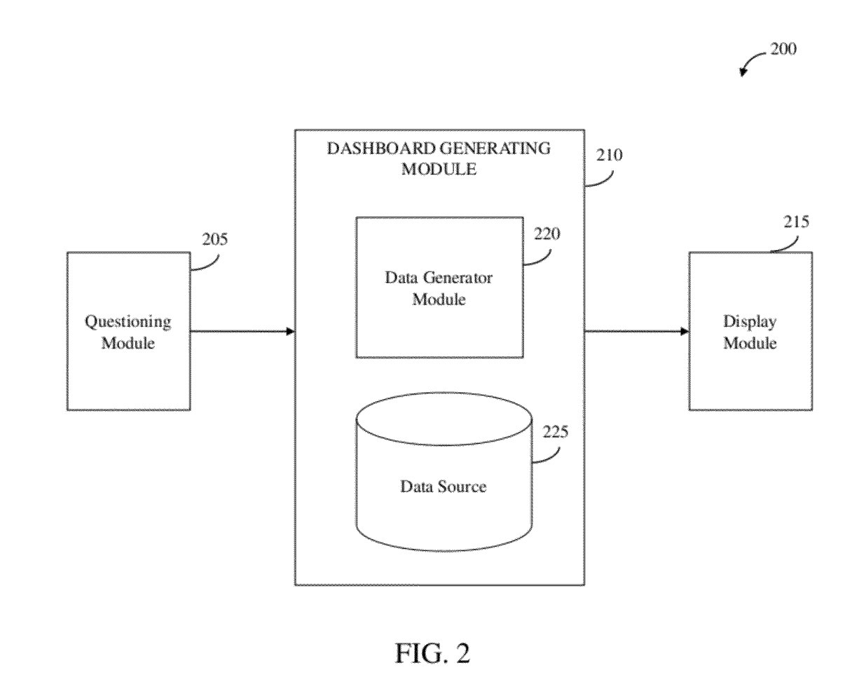

The server 115 includes the system, such as a system 120, to create business intelligence dashboard mockup. The system 120 may be placed on the server 115 to interact with the clients 110. In an embodiment, the network 105 is the Internet, the clients 110 include one or more user and the server 115 includes a web server. The system 120 may send a questionnaire from the server 115 to the clients 110 and may receive input data, corresponding to the questionnaire, from the clients 110 through the network 105. The system 120 is explained further, in more details, in conjunction with FIG. 2.

FIG. 2 illustrates a block diagram of a system 200 for creating business intelligence dashboard mock-up, in accordance with an embodiment of the disclosure. In an embodiment, the system 200 is an online system that is accessible by a user through a network, such as Internet (as explained earlier in conjunction with FIG. 1). The system 200 includes a questioning module 205, a dashboard generating module 210 communicably coupled to the questioning module 205 and a display module 215 communicably coupled to the dashboard generating module 210. To utilize the system 200 for creating a business intelligence dashboard, the user may be required to register with the system 200 to login into the system 200. After registering with the system 200, the user may be provided with a login screen (not shown) to enter login details therein. The login screen may be provided to the user for verifying the authenticity of the user. A successful login allows the user to enter into the system 200 to create the business intelligence dashboard.

The questioning module 205 provides a questionnaire to the user and receives input data, corresponding to the questionnaire, from the user. The questionnaire includes a plurality of questions (hereinafter referred to as the “questions”) corresponds to at least one of a customer information and a report information. The customer information may include, but is not restricted to, information corresponding to one of the user, a client of the user, any other user, an organization, and a department for whom/which one or more reports need to be prepared. For example, customer information includes a customer name, customer code and the like. Further, the report information includes information corresponding to one or more reports (hereinafter referred to as the “reports”) that are to be generated and displayed in a dashboard.

Each report may be linked to a functional area for business intelligence. The dashboard may be generated for different functional areas such as supply chain, manufacturing, order management, human resource and the like. Further, the report information includes information corresponding to dimensions, measures and the reports that are to be generated. The information corresponding to the dimensions includes names and values of the dimensions associated with the functional area.

The information corresponding to the measures includes measures name and probable range of values for each measure. The user may provide the probable range of values to generate graphs in the one or more reports. For example, “booked quantity” and “margin %” may be provided by the user as measures names. The probable range may be provided by providing a minimum range and a maximum range for each of the “booked quantity” and “margin %”. Further, the information corresponding to the measures includes a type of each measure and an aggregation rule that is to be applied on each measure. The types of each measure include “currency”, “number”, “percentage” and the like. Further, the aggregation rule, may include sum, average and the like, that may be applied to the probable range of values corresponding to the measures.

Further, the information corresponding to the reports is required to generate the reports in the dashboard. Each report has a name and is tied to a functional area. Further, each report can be of a particular type based on a type of chart/graph that is included in the report such as PIE chart, doughnut, BAR, column, line, stacked bar, stacked column, radar, dial gauge, traffic lights and the like. The user may provide the type of the report that the user wants to generate in the dashboard for a particular functional area. In one embodiment, the user may provide the type of report by entering the type of report in the questionnaire. In another embodiment, the user may be provided with various options, corresponding to various types of reports, to select the type of report therefrom.

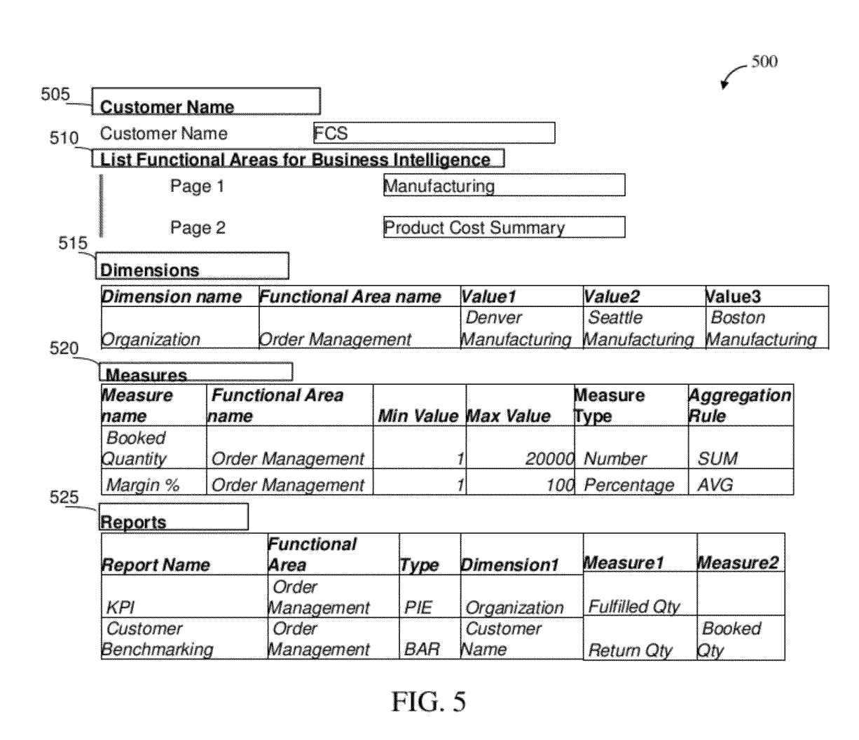

Also, the user may be enabled to drill down from one report to another, if the functional area includes more than one report. Further, the user may be enabled to drill down from one report corresponding to one functional area to another report corresponding to another functional area. For this, in an embodiment, the user may be enabled to set the hierarchy of the reports. Further, the user may be enabled to provide the name of a report, of the reports, to which the higher level report should drill down to. For example, the user may drill down to a detailed report from a higher level report. The questionnaire and drill down corresponding to the reports are explained in more detail in conjunction with FIG. 5.

In an embodiment, the questionnaire further includes features that may enable the user to decide about the dashboard that the user may want to create. Such features may provide a plurality of options to the user to select one or more options therefrom. Accordingly, the user may utilize one or more features by selecting one or more options, corresponding thereto, to provide them as a part of input data. For example, the questionnaire may provide features, to the user, for visualizing the dashboard such as layout of the tables, charts, pivot tables and prompts. Further, the user may be facilitated to take part in gathering sessions or conference room pilots to finalize the layout of the reports. The user's selection may be received as the input data and the reports may be generated accordingly.

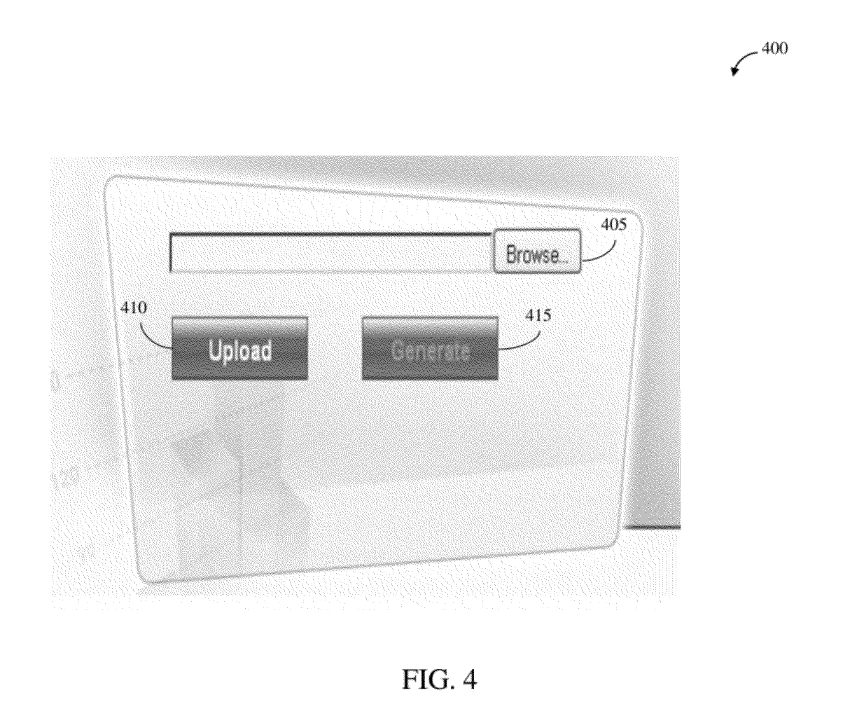

The user may upload the input data corresponding to the questionnaire to generate a dashboard mock-up for generating the reports corresponding to the input data. The uploading of the input data to generate the dashboard is explained further in conjunction with FIG. 4.

Further, the dashboard generating module 210 includes a data generator module 220 and a data source 225. The data source 225 may include one or more databases to store the input data corresponding to the questions provided, to the user, by the questioning module 205. Each of the databases may include one or more base tables (hereinafter referred to as the “tables”) to store the input data. In an embodiment, each question, of the questionnaire, is stored as a data field in a table of the database of the data source 225. Accordingly, the input data corresponding to the questions may be stored as values of the data field in the database.

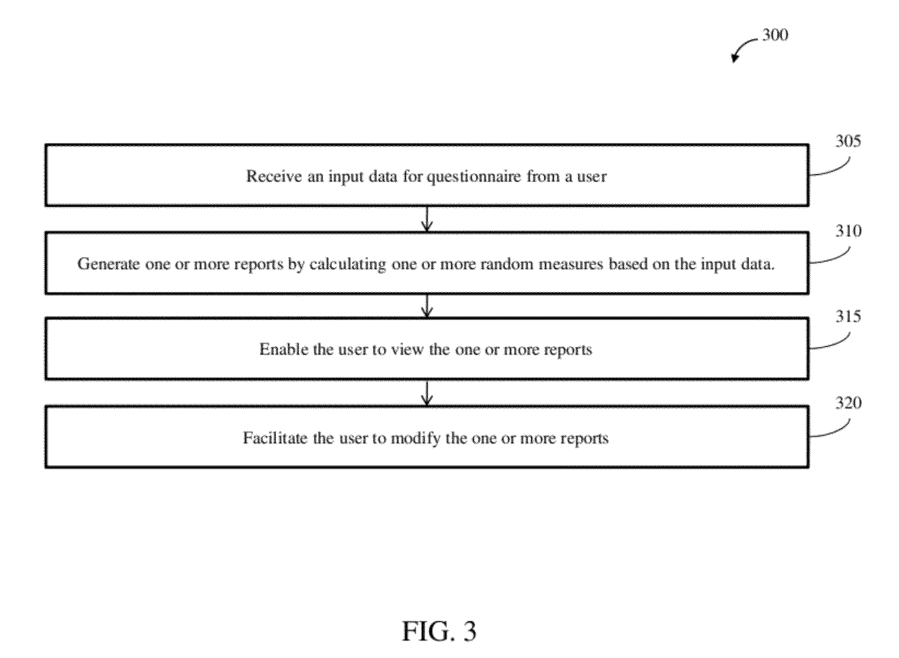

The data generator module 220 is configured to calculate one or more random measures, for each measure, by analyzing probable range of values corresponding to the measure. The random measures may include values that exist between minimum and maximum values provided by the user through the input data. Further, the random measures may be used for plotting the charts, graphs and tables in the dashboard. The data generator module 220 may generate the one or more reports based on the one or more random measures. It may be appreciated by any person having ordinary skills in the art that the data generator module 220 may calculate random measures automatically by utilizing a data generation algorithm. Further, due to this, the data generator module 220 may generate the one or more reports by utilizing the random measures without requiring the real data from the user to generate the one or more reports. Thus, the user need not gather the real data for measures (corresponding to a functional area, explained later in this disclosure in conjunction with FIG. 3 and FIG. 5) to provide to the system 200 for generating the one or more reports.

The one or more reports generated, by the dashboard generating module 210, may be displayed to the user by the display module 215. In an embodiment, the display module 215 enables the user to view the generated reports by utilizing a template such as an excel template. For example, the data, corresponding to the one or more reports, may be placed in an excel template to form an excel file. This data may be read from the excel file to generate the report. For example, one or more macros may be written to read the data from the excel file. Further, the user may be allowed to download the excel file to view the generated reports. Further, for this, the user may be required to enable the functionality of macros to run the macro to view the generated reports. In an embodiment, the one or more reports may be displayed to the user in XML or UDML format.

Further, the display module 215 may display database of the data source 225 to the user to enable the user to modify the input data that was stored in the data source 225. The user may then modify the inputted data for one or more questions of the questionnaire to regenerate the reports for the same functional area. This modification in the inputted data may refresh the reports accordingly to reflect the changes therein. Further, the user may create one or more new reports by modifying the functional area in the stored input data. This may enable the user to generate and view reports for different purposes.

Further, in an embodiment, the user may be facilitated to save the generated dashboard (reports) locally on his/her electronic device, such as Client 1 110a (as explained in conjunction with FIG. 1) corresponding to the user 1. Thereby the user may be enabled to print the reports that are saved locally.

FIG. 3 is a flowchart illustrating a method 300 for creating business intelligence dashboard mock-up, in accordance with an embodiment of the disclosure. In an embodiment, the method 300 may require a user to register with a system, such as the system 200, to access the system and to create the business intelligence dashboard. The order and number of steps in which the method 300 is described is not intended to be construed as a limitation.

At step 305, an input data, for questionnaire, is received from the user. The questionnaire may be provided to the user to be filled in with the information (input data) corresponding to the one or more reports that are required to be generated by the user. The questionnaire may include, but is not limited to, one or more questions corresponding to customer information and the report information such as name of the customer (or user), functional areas, dimensions corresponding to the functional area, one or more measures for each dimension and probable range of values for each measure, type of each measure, types of reports for each functional area, various search criteria such as filters and prompts, and the like.

The input data received from the user may be stored in the database for generating the dashboard (one or more reports). In an embodiment, the user may be provided with a web form containing the questions (questionnaire) for generating the dashboard. In this, the user may fill in the form and upload the filled form to generate the dashboard. Uploading of the questionnaire is explained in conjunction with FIG. 4.

At step 310, one or more reports may be generated by calculating one or more random measures based on the input data. The random measures may be generated from the inputted probable range of values, such as minimum value and the maximum value for a measure. The range of values may be analyzed to generate one or more random measures dynamically. The random measures may be generated within the range of the values to generate the charts and graphs for generating one or more reports (hereinafter referred to as the “reports”). It may be appreciated by any person having ordinary skills in the art that, as the random generated automatically through the inputted probable range of values, the generation of the one or more reports is not dependent on the provisions of real data for measures associated with the functional area.

Further, the reports may be generated based on the input data such as an aggregation rule that may be applied on the random measures to generate appropriate values for a corresponding measure. The aggregation rule may be provided as the input data, by the user, to be applied on various values of the measures. Further, the aggregation rule and the random measures may be understood more clearly, when read, in conjunction with FIG. 2 and FIG. 5.

Further, the report generation may be based upon other input data such as types of the reports, corresponding to a functional area. The types of the reports may provide information about the type of charts, graphs and other visual images that need to be included in the reports. The types of reports may include, but are not restricted to, PIE chart, doughnut, BAR, column, line, stacked bar, stacked column, radar, dial gauge, and traffic lights.

In one embodiment, a data model may be prepared based on the input data to generate reports. The data model may organize data and include relationship between data of the input data received from the user. Further, the data model may set a hierarchy between data and/or reports of the dashboards. For example, if the input data, received from the user includes information corresponding to two reports and also information about the drill down between the two reports, then the data model may be prepared to organize the data and to depict the relationship between the two reports. The higher level report may be set higher in the hierarchy and the detailed report may follow the higher level report. For example, a report for manufactured products in last ten years may drill down to specific details of market analysis of each manufactured product. Further, the data model may be read to generate the reports.

At step 315, the user may be enabled to view the reports. The data corresponding to the generated reports may be placed in a template such as an MS Excel template. Further, a corresponding macro may be written to read the data and to generate the reports in a file corresponding to the template. For example, if the data is placed in an MS Excel template then a macro may be written to read the Excel file and to generate the report(s). The generated report may be displayed to the user in an MS Excel format. This enables the user to view the reports in MS Excel by running the macro. In an embodiment, the one or more reports may be displayed to the user in XML or UDML format. Further, this enables the user to download the file to save on a local system and to perform various operations thereon. For example, the user may download the report and give a print command for printing the reports.

Further, the user is enabled to view the database containing data corresponding to the input data. At step 320, the user is enabled to modify the generated reports. The reports may be modified by modifying the data in the database. For example, the user may change the probable range of the values of the measures in the database. Consequently, the report may be refreshed to reflect the corresponding changes therein. Further, the user may be enabled to change the functional areas, hierarchy between the reports to generate one or more new reports. Accordingly, the change may be reflected in the report.

FIG. 4 illustrates an exemplary view of questionnaire uploading screen 400, in accordance with an embodiment of the disclosure. The user may be provided with an uploading screen 400 that may enable the user to fill in the questionnaire to provide an input data. Further, the uploading screen may enable the user to upload the filled questionnaire to store the input data in a base table in a database of a data source. In one embodiment, the user may download the questionnaire and enter the input data corresponding to each question of the questionnaire. Further, the user may browse the questionnaire from a browse button 405 and may upload the filled questionnaire back to a system such as the system 200. The filled questionnaire (hereinafter referred to as “input data”) may be uploaded by utilizing an upload button 410. The input data may be stored in a base table in a database of a data source. After uploading the input data to the system, the user may give command, such as generate 415 to generate the dashboard. The dashboard may contain one or more reports based on the input data provided to the system through the filled questionnaire.

FIG. 5 is an exemplary database 500, in accordance with one embodiment of the disclosure. FIG. 5 depicts different base tables of the database 500 of a data source. Further, each table stores input data corresponding to the questionnaire provided to a user for filling in data. The input data may be received from the user for creating a dashboard mockup. The database 500 depicts questionnaire and the inputted data corresponding to customer information and report information.

The customer information may include information corresponding to personal information of a customer such as a customer name, customer code and the like. The customer may include, but is not restricted to, at least one of: the user who provides the input data, client of the user, an organization and any other user or business unit for whom/which the dashboard is required to be generated. For example, the user may generate the report for his/her own company or for other user's company. Thus, in both the cases the customer may be a different person for whom the report is being generated. It may be appreciated by any person skilled in the art that the customer information may enable the user to narrow down the search criteria to a particular customer. For example, if the user wants to view a report corresponding to a particular customer, the user may enter the name of the customer in a search field to view the corresponding report.

The report information may be utilized to generate one or more reports in a dashboard and to establish a link between reports. The report information may include, but is not limited to, one or more functional areas, such as functional areas 510, dimensions associated with each functional area, such as dimensions 515, various measures for the functional area, such as measures 520 and data corresponding to the reports that are to be generated, such as reports 525.

The functional areas 510 may refer to different functioning units for business intelligence. Further, the functional areas 510 may include names of the functional units for which a dashboard is required to be generated. For example, the reports may be generated for the functioning units such as Supply Chain, Manufacturing, Product cost summary, Order Management, Production, and the like. FIG. 5 depicts ‘Manufacturing’ and ‘Product Cost Summary’ as the functional areas for Business Intelligence.

Dimensions 515 may correspond to the functional areas 510. Dimensions 515 may include one or more dimensions names and values corresponding thereto. FIG. 5 depicts a dimension name “Organization” corresponding to a functional area “Order Management”. The dimension values, corresponding to the dimension name, may be provided such as ‘Denver Manufacturing’, ‘Seattle Manufacturing’, and ‘Boston Manufacturing’ (as shown).

The measures 520 may correspond to the functional area 510. The measures 520 may include measures names, measure types, and probable range of value for each measure. The measure type may include, but is not limited to, currency, numbers, and percentage. Further, the probable range of values may include minimum value and maximum value for the measure. These values may give an idea about the values for which the report is required to be generated. Thus, these values may be analyzed to determine random measures, between the probable range, for preparing the report. For example, in FIG. 5, the minimum and maximum values given for ‘Booked Quantity’ are ‘1’ and ‘20000’ respectively. Similarly, the minimum and maximum values given, respectively, for ‘Margin %’ are ‘1’ and ‘200’. The random measures may be determined within the range provided by minimum and maximum values of the measures i.e. ‘Booked Quantity’ and ‘Margin %’.

Further, the measures 520 may include aggregation rules that may be applied to values, corresponding to the measures names, to generate an appropriate value for generating charts/graphs in the reports. The aggregation rule may correspond to each measure name and may include, but is not limited to, mathematical operations such as Sum, Average and the like.

Further, the reports 525 may include names of the various reports that are expected to appear in the generated dashboard. The reports may be linked to a particular functional area. Further, the reports 525 may include types of the reports and the dimensions and measures that need to be present in the report. The type of report may include, but are not limited to, PIE, BAR, Gauge, doughnut, column, line, stacked bar, stacked column, radar, dial gauge and traffic lights.

Further, the user may be provided with flexibility of drilling down from one report to a detailed report. The user may be provided with a feature that allows the user to provide the name of the report to which drill down should be possible. For example, in reports 525, report names ‘KPI’ and ‘Customer Benchmarking’ are shown as inputted by the user. The user may provide the name of the report ‘Customer Benchmarking’ to which the user wants to drill down to. This may enable the user to drill down from ‘KM’ to ‘Customer Benchmarking’ for detail information about ‘KM’.

Further, in an embodiment, the questionnaire may include various features corresponding to the dashboard that the user wants to create. Such features may provide a plurality of options to the user to select at least one option therefrom. Accordingly, the user may utilize one or more features by selecting one or more options, corresponding thereto, to provide them as a part of input data. For example, the user may be facilitated with a feature of selecting a particular dimension to be prompted in the dashboard. Further, the questionnaire may provide features, to the user, for visualizing the dashboard such as layout of the tables, charts, pivot tables and prompts. Further, the user may be facilitated to take part in gathering sessions or conference room pilots to finalize the layout of the reports. The user's selection may be received as the input data and the reports may be generated accordingly.

It may be appreciated by any person skilled in the art that the database and the questionnaire are not restricted to the explanation of FIG. 5. Further, various tables and questions may be included to enhance the flexibility for generating the report. Also, various new features may be provided to enable the user to select various options corresponding thereto to make the dashboard more presentable as per the user's requirements, such as color selection for the reports and the like.

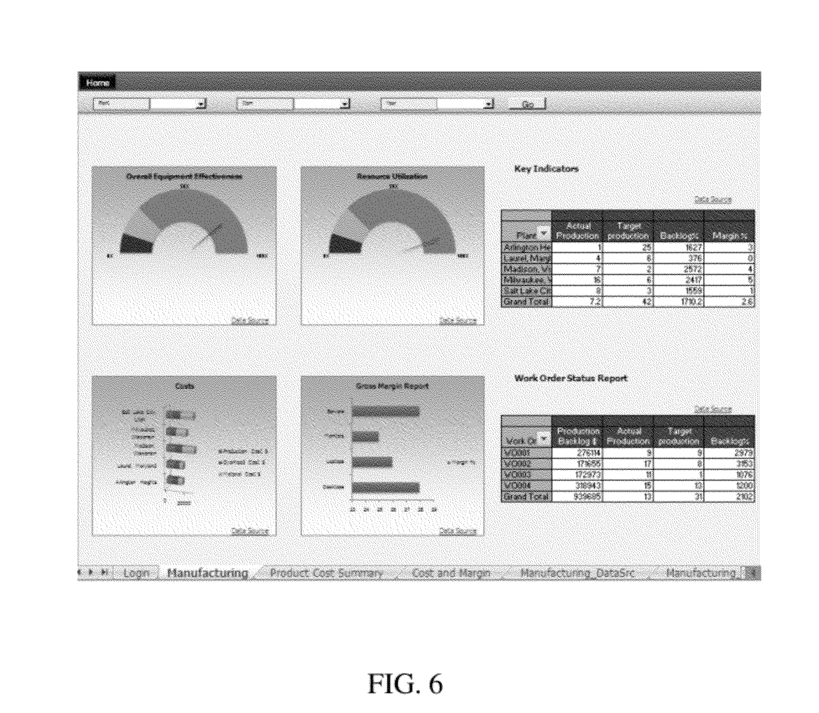

FIG. 6 illustrates an exemplary dashboard mock-up generated by implementing the method, in accordance with an embodiment of the present disclosure. The dashboard displays reports in various view modes such as in form of bar graph, pie chart and tables. The dashboard mockup is an online system in which the user is also provided with the facility to view and modify the data-source used to generate the report in the mockup dashboard. Upon modifying the data-source, the reports in the dashboard get refreshed instantly to reflect the changes accordingly.

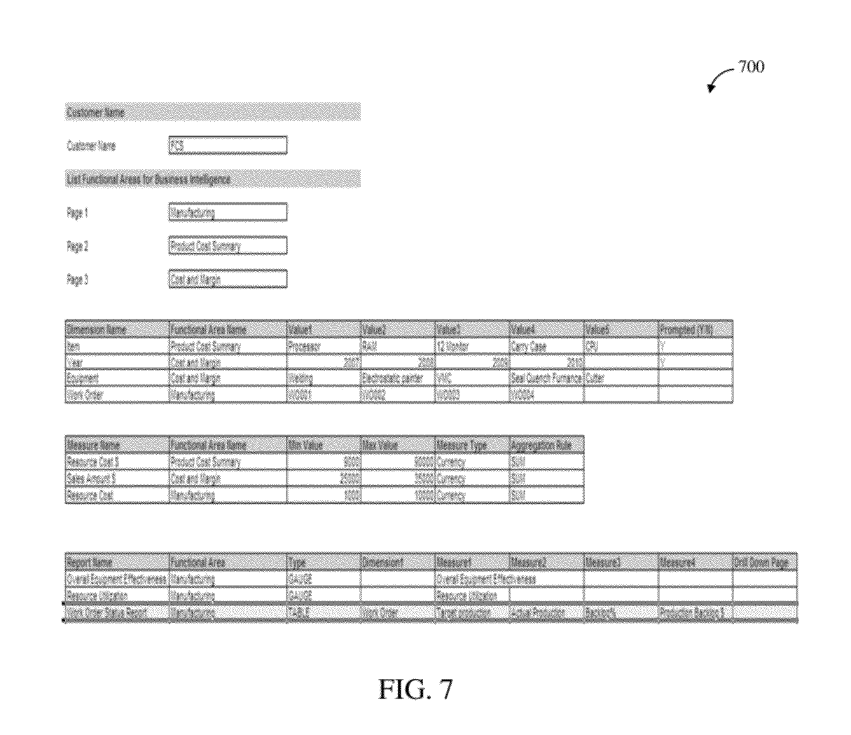

FIG. 7 illustrates an exemplary view of questionnaire for creating business intelligence dashboard mockup, in accordance with an embodiment of the present disclosure. The questionnaire includes questions corresponding to ‘Manufacturing’ domain. Further, FIG. 7 depicts input data, corresponding to the questions, that may be filled in by a user to create a dashboard mockup.

The questionnaire, as depicted in FIG. 7, includes customer information and report information. The customer information corresponds to personal information of a customer for whom the dashboard mock-up is required to be generated. For example, ‘Customer Name’ may be asked (from the user) as customer information (as shown). In case, if various dashboard mock-ups are available for different customers then the customer information may be utilized to narrow down search criteria to a particular customer.

Further, the report information may be utilized to generate one or more reports in a dashboard and to establish a link between reports. The report information includes ‘Functional Areas’, ‘Dimensions’, ‘Measure Name’, and ‘Reports’. The ‘Functional Areas’ may correspond to different functional units for Business Intelligence. FIG. 7 depicts ‘Manufacturing’, ‘Product Cost Summary’ and ‘Cost and Margin’ as functional areas for generating the dashboard mock-up. Each functional area may include one or more reports that may be drilled down to another detailed report. This is explained later in this disclosure.

The ‘Dimensions’ may include one or more dimension names and values corresponding thereto. Each of the dimension names may correspond to one of the functional areas. For example, FIG. 7 shows various dimension names as ‘Item’, ‘Year’, ‘Equipment’, and ‘Work Order’ corresponding to functional areas.

The ‘Measure Name’ may include name of a measure corresponding to each functional area. FIG. 7 shows the ‘Measure Name’ as ‘Resource Cost $’, ‘Sales Amount $’ and ‘Revenue Cost’ corresponding to the ‘Functional Areas’. Further, each measure may include ‘Measure Type’ such as ‘Currency’, ‘Measure Value’, and ‘Aggregation Rule’. ‘Measure Value’ includes a probable range of values for each measure that may be utilized to generate random values (hereinafter referred to as ‘random measures’) for report generation. The random measures are already explained in conjunction with FIG. 5 and thus, corresponding description has not been repeated here for the sake of brevity. Further, ‘Aggregation Rule’ may correspond to each measure and may include mathematical operations that may be applied over the probable range of values to generate random measures. As shown, the ‘Aggregation Rule’ includes ‘SUM’ as the mathematical operation that may be utilized in generating the data (random measures) to generate the reports.

Further, ‘Reports’ may include name of the reports that need to be included in the dashboard mock-up. Further, the ‘Reports’ may include type of the reports. For example, reports' names such as ‘Overall Equipment Effectiveness’, ‘Resource Utilization’, ‘Work Order Status Report’ may be of type as ‘gauge’, ‘gauge’ and ‘table’ respectively (as shown).

Further, the user may be provided with flexibility of drilling down from one report to another report. The user may be provided with a feature that allows the user to provide the name of the report to which drill down should be possible. Further, the user may drill down from a report of one functional area to another report corresponding to another functional area. For example, the user may set hierarchy of the reports in a way such that the user may drill down to reports corresponding to ‘Cost and Margin’ from a report corresponding to ‘Product Cost Summary’ to view detailed information corresponding to the ‘Product Cost Summary’.

The description of questionnaire may be understood more clearly when read in conjunction with FIG. 5. Further, the questionnaire is not restricted to the description of FIG. 7 and various modifications may be possible, in questionnaire, to provide more flexibility to the user in generating the reports.

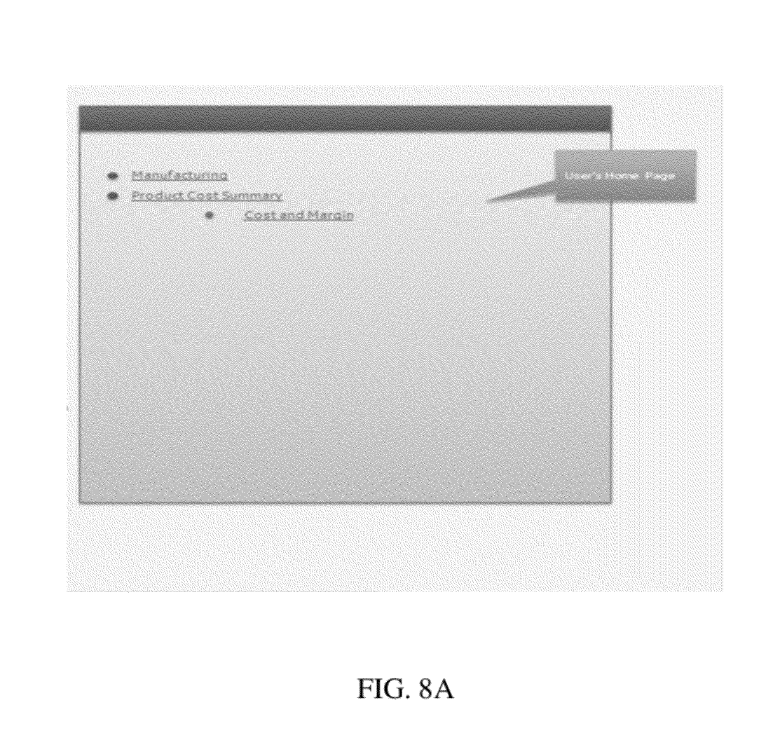

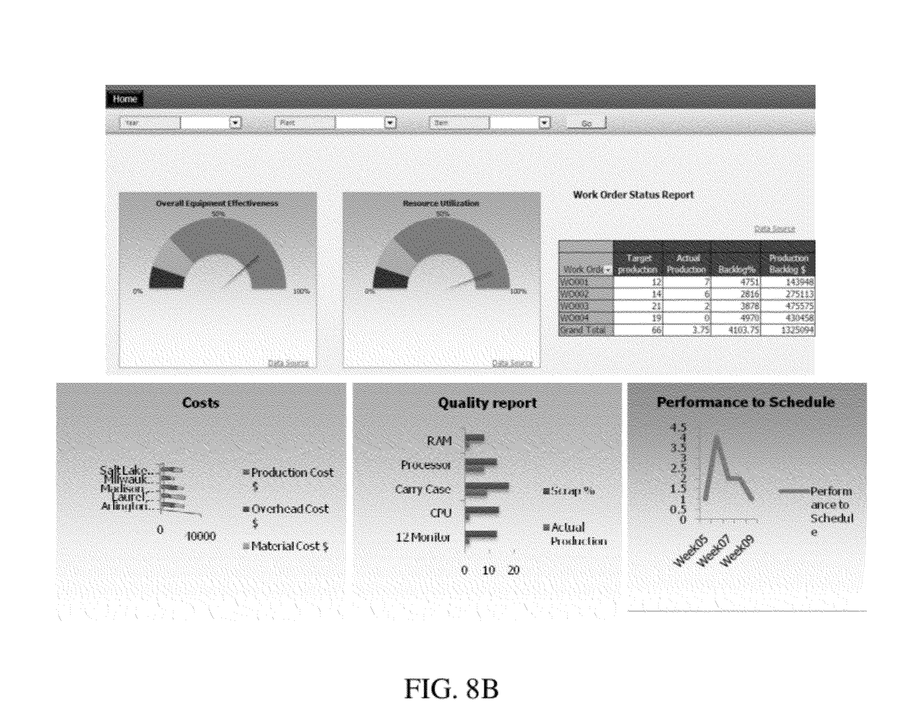

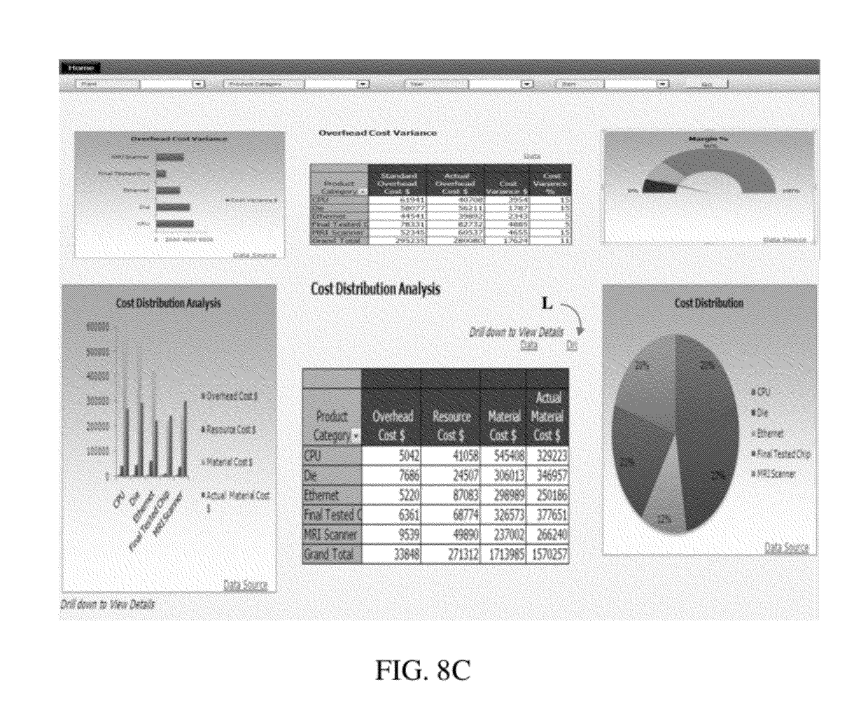

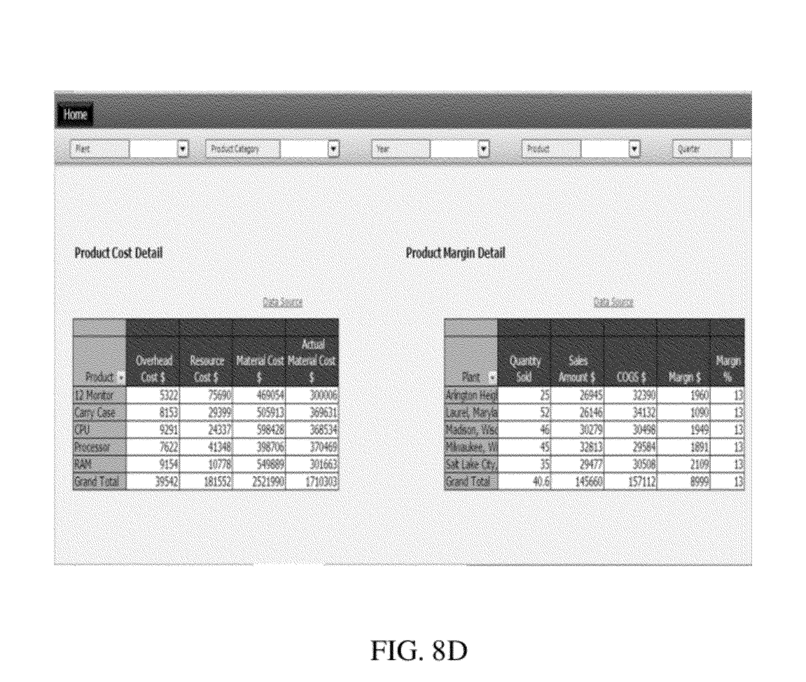

FIGS. 8A-8D illustrate exemplary view of business intelligence dashboard mockup corresponding to the questionnaire illustrated in FIG. 7, in accordance with an embodiment of the present disclosure. The user may fill-in data (hereinafter referred to as ‘input data’) corresponding to the questionnaire to generate the dashboard mock-up (as explained in conjunction with FIG. 7). Further, the dashboard mock-up may include various reports that may be generated according to the input data. FIGS. 8A-8D are explained (below) with reference to the questionnaire as explained in the FIG. 7.

FIG. 8A depicts a home page of the dashboard mock-up that may be visible to the user to view various reports. The home page provides links to various functional areas to view the reports corresponding thereto. For example, the user may click on ‘Product Cost Summary’ to view the reports corresponding to this ('Product Cost Summary') functional area.

Further, FIG. 8A depicts hierarchy of functional areas that define capability of the user to drill down from one report corresponding to one functional area, such as ‘Product Cost Summary’, to reports of another functional area, such as ‘Cost and Margin’.

FIG. 8B, FIG. 8C and FIG. 8D illustrates various charts and tables corresponding to functional areas such as ‘Manufacturing’, ‘Product Cost Summary’ and ‘Cost and Margin’ respectively. FIG. 8C depicts a link ‘L’ for enabling the user to drill down to another report for detailed description. This feature of drilling down may be available to the user if the user sets the hierarchy of the reports by utilizing one or more options that may be provided, to the user, through the questionnaire.

The user may be provided with data source corresponding to each report. This may enable the user to modify data corresponding to a report to make modifications therein. The example of FIGS. 8A, 8B, 8C may be understood more clearly in light of the description of FIG. 2, FIG. 5, and FIG. 7. Further, the scope of the present invention is not restricted by the examples and embodiments as provided in this disclosure. Various other examples and embodiments may be applicable and provided to support the invention without departing from the scope of the invention.

The invention disclosure as described above has numerous advantages. Based on the aforementioned explanation, it can be concluded that the various embodiments of the present invention may be utilized for creating business intelligence dashboard mockup. The embodiments mentioned above describe a method, and an online system that may enable multiple users to access the system to create a dashboard mockup (hereinafter referred to as the “dashboard”). The dashboard enables each user of the users to create various reports in various view modes. Further, the method and the system may facilitate the user to access a corresponding data source to modify the reports by altering the data source. This enables the user to regenerate various reports with minimum efforts and to view the regenerated reports of various types instantly on modifying the reports.

Further, the invention may analyze an input data provided by the user to generate more appropriate data for creating the reports. For example, the user may just need to input a probable range of values for creating various types of the reports. The invention may analyze the probable range inputted by the user and accordingly, may generate more appropriate values to create various reports. For example, the user may enter just a minimum and maximum value for a measure and the system may generate a random measures based on the minimum and maximum values entered by the user. This auto-generation of the values (random measures) by the system of the invention may reduce the user's time and effort in thinking and entering each and every value for creating the reports. Further, due to automatic generation of the random measures for report generation, the user need not wait to gather the real data corresponding to the functional area to prepare the reports.

Further, the user may be facilitated to modify the values generated by the system or any input provided by the user to modify the reports. In one embodiment, the user is capable of regenerating the reports for the same functional area as inputted by the user. In another embodiment, the user may generate whole new reports of different type and for different functional areas by modifying the inputted data corresponding to the functional area that was inputted by the user. This saves most of the time and efforts that may otherwise be required in generating the new reports for different functional areas and for different values.

Moreover, the invention facilitates the users to utilize various other features of the system such as visualizing the dashboard before actual creating it. The user may be facilitated with features such as layout of the tables, charts, and pivot tables. Further, the system may enable the user to set prompts for various fields, such as dimensions, that may be prompted in the dashboard. Further, the user may be facilitated to take part in gathering sessions or conference room pilots to finalize the layout of the reports. The user's selection may be received as the input data and the reports may be generated accordingly.

Also, the system supports a variety of charts and graphs such as pie, doughnut, bar, column, line, stacked bar, stacked column, radar, dial gauge, and traffic lights. Further, the system may allow the user to drill down between the generated reports. Furthermore, the generated dashboard may facilitate the user with filters and prompts that allow the user to specify search criteria. For example, on selection and application of filters, the corresponding reports in the dashboard refresh and show data for the selected search criteria.

The invention is not limited to the advantages as mentioned above. Various features for facilitating the user with various new options may be provided to ease the user in preparing the reports. Further, the invention is not limited to the embodiments as mentioned above in this disclosure. Accordingly, the Detailed Description and corresponding figures are to be regarded as illustrative examples of the present disclosure, rather than in restrictive sense. All such possible modifications are intended to be included within the scope of the present disclosure.

The present invention may also be embodied in a computer program product for creating business intelligence dashboard. The computer program product may include a non-transitory computer usable medium having a set program instructions comprising a program code for enabling the system to facilitate the user with various options to create various reports. The set of instructions may include various commands that instruct the processing machine to perform specific tasks such as tasks corresponding to analyzing input data to create random measure for creating various charts/graphs for the reports. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

The foregoing description sets forth numerous specific details to convey a thorough understanding of embodiments of the invention. However, it will be apparent to one skilled in the art that embodiments of the invention may be practiced without these specific details. Some well-known features are not described in detail in order to avoid obscuring the invention. Other variations and embodiments are possible in light of above teachings, and it is thus intended that the scope of invention not be limited by this Detailed Description, but only by the following Claims.

What is claimed is:

1. A computer-implemented method for creating business intelligence dashboard mockup, comprising:
receiving an input data for a questionnaire, the input data being received from a user;
calculating one or more random measures by analyzing one or more values from the input data;
generating one or more reports based on at least one of the one or more random measures and the input data, the one or more reports beings generated for one or more report types based on the input data; and
enabling the user to view the one or more reports, the reports being modifiable by the user,
wherein the user is facilitated to modify the input data to modify the one or more reports, thereby enabling the user to regenerate the one or more reports.

2. The method of claim 1, wherein the questionnaire comprises questions corresponding to at least one of a customer information and a report information, the report information corresponding to the one or more reports.

3. The method of claim 1 further comprising storing the input data in a data source.

4. The method of claim 1 further comprising preparing a data model from the input data, the data model being prepared to generate the one or more reports.

5. The method of claim 1, wherein the one or more random measures are calculated for preparing one or more charts in the one or more reports.

6. The method of claim 1 further comprising enabling the user to drill down from one report to another report of the one or more reports based on the input data.

7. The method of claim 1 further comprising utilizing a template to display the one or more reports to the user.

8. The method of claim 1 further comprising enabling the user to perform one or more operations on the one or more report.

9. The method of claim 1 further comprising enabling the user to visualize the one or more reports based on the input data, the one or more reports being visualized prior to generating the one or more reports.

10. The method of claim 1 further comprising facilitating the user with one or more features to specify search criteria, the search criteria enabling the user to search out data from the one or more reports.

11. An online system for creating business intelligence dashboard mockup, the system comprising:
a questioning module capable of receiving an input data for a questionnaire, the questionnaire being provided to a user by the questioning module;
a dashboard generating module comprising:
a data source for storing the input data, and
a data generator module, the data generator module configured to:
calculate one or more random measures, the one or more random measures being calculated by analyzing one or more values from the input data; and
generate one or more reports based on the one or more random measures and the input data, the one or more reports beings generated for one or more report types based on the input data; and
a display module configured for enabling the user to view the one or more reports,
wherein the user is facilitated to modify the input data in the data source to modify the one or more reports.

12. The system of claim 11, wherein the questionnaire comprises questions corresponding to at least one of:
a customer information corresponding to a personal information of a customer; and
a report information for generating the one or more reports, the report information comprising:
a functional area corresponding to the one or more reports;
a dimension information corresponding to the functional area, the dimension information comprising one or more dimension names and one or more values corresponding to each of the one or more dimension names;
a measuring information corresponding to the functional area, the measuring information comprising at least one of:
one or more measure names and a measure type corresponding to each of the measure names,
a range of values corresponding to each of the measure names, the range of values being utilized for generating one or more charts for the one or more reports, and
an aggregation rule for applying to the one or more measures; and
a report generation information corresponding to the functional area, the report generation information comprises at least one of
one or more types of the one or more reports for being generated, and
drill down information corresponding to the one or more reports.

13. The system of claim 11, wherein the dashboard generating module further configured to prepare a data model to generate the one or more reports, the data model being prepared from the input data.

14. The system of claim 11, wherein the one or more random measures are utilized for preparing one or more charts for the one or more reports.

15. The system of claim 11, wherein the display module capable of utilizing a template to enable the user to view the one or more reports.

16. The system of claim 11, wherein the display module enables the user to visualize the one or more reports based on the input data.
